(19) United States
(12) Patent Application Publication
(10) Pub. No.: US 2025/0356291 A1
(43) Pub. Date: Nov. 20, 2025

(54) ADAPTIVE ENGAGEMENT PLATFORM WITH PERSONALIZED SUPPORT FEATURES

(71) Applicants: Robert Joseph, Atlanta, GA (US); Craig Preston, Silver Spring, MD (US)

(72) Inventors: Robert Joseph, Atlanta, GA (US); Craig Preston, Silver Spring, MD (US)

(21) Appl. No.: 19/206,960

(22) Filed: May 13, 2025

Related U.S. Application Data
(60) Provisional application No. 63/648,131, filed on May 15, 2024.

(51) Int. Cl. G06Q 10/0633; G06F 9/451; G06F 16/332; G06F 16/335

(52) U.S. Cl. CPC G06Q 10/0633; G06F 9/453; G06F 16/3326; G06F 16/335

(57) ABSTRACT

In professional development, where learning new skills and managing complex projects are crucial, the platform introduces a tailored, innovative solution. The platform caters to a wide array of applications, from individual learning and skill acquisition to intricate task execution, and collaborative project coordination, emphasizing personalization and adaptability in engagement practices. The benefits of this software platform include its efficacy in enhancing learning outcomes, productivity, and project completion rates. By integrating customizable engagement plans and adaptive communication mechanisms, this software system aims to revolutionize the way individuals and teams navigate the challenges of professional growth and complex projects, setting a new standard for sustained engagement and success.

### CROSS-REFERENCE TO RELATED APPLICATIONS

This application is a Utility Patent application claiming priority to U.S. Provisional Patent Application Ser. No. 63/648,131, filed on May 15, 2024, which is incorporated by reference herein in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1) Field of the Invention

The invention relates to the field of software and AI for improving user and management engagements and, more specifically to an adaptive engagement platform for task execution and skill acquisition with personalized support features including customizable engagement plans, behavioral incentives, and hybrid automated and human.

### 2) Description of Related Art

Currently the state of the art includes program management tools, Learning Management Systems (LMS), employee engagement platforms, Crew Resource Management systems (CRM), corporate training platforms, online community platforms, behavioral change applications and gamified learning environments. Each addresses particular aspects of user engagement though, through a comparative analysis, none provide a full suite solution as the platform provides. In complex tasks and intricate projects, challenges often impede progress. A primary factor is diminishing engagement due to insufficient personalized support and intrinsic motivation. This challenge is exacerbated in busy, distracting environments, making consistent focus harder. The central challenge in executing complex processes and projects is maintaining momentum in the face of obstacles. For individuals and organizations, obstacles like engagement lapses, lack of tailored experiences, and insufficient feedback act as barriers to progress. The platform enhances engagement and offers customized support, smoothing the path to successful outcomes and minimizing friction.

Coordination significantly impacts collaborative project efficiency, requiring synchrony among stakeholders. The lack of robust coordination mechanisms can lead to confusion, duplicative efforts, and inefficiencies, detracting from the project's commitment and advancement. A widespread concern is the disconnect between theoretical knowledge and practical application, leaving individuals well-versed in theory but uncertain about its real-world application. The resulting uncertainty, combined with unclear tasks and expected outcomes, can stall progress or create misaligned efforts. Motivation is crucial for task completion. Initial enthusiasm often fades as people progress, influenced by factors like limited insight into the consequences of their actions or the lack of a compelling narrative tying their efforts to meaningful outcomes.

The absence of accountability mechanisms contributes to declining discipline, leading to increased procrastination and elevated task incompletion rates. In an organizational context, this deficiency can extend beyond individual projects, contributing to broader inefficiencies and the failure to meet objectives.

To address these complex challenges, a conventional approach to task management and engagement is insufficient. An innovative strategy offering personalized engagement, mitigating distractions, ensuring coordination, bridging theoretical learning and practical application, bolstering motivation, and reinforcing accountability is essential. The platform provides a comprehensive solution having the potential to enhance individual experiences and contribute to organizational success, ensuring projects and tasks are consistently seen through to a successful conclusion.

Engagement platforms have become increasingly prevalent in various sectors, including education, corporate training, and personal development. These platforms aim to facilitate task execution, skill acquisition, and user retention through a combination of digital tools and interactive features. As technology advances, there is a growing demand for more sophisticated and personalized engagement solutions that can adapt to individual user needs and preferences.

Traditional engagement platforms often struggle to maintain consistent user participation and motivation over extended periods. This challenge is particularly evident in scenarios requiring long-term commitment, such as extended learning programs or complex project management tasks. Users may experience fluctuations in motivation, leading to decreased engagement and potentially abandoning their goals or objectives. Many existing platforms offer a one-size-fits-all approach, which may not adequately address the diverse needs and learning styles of individual users. This lack of personalization can result in suboptimal user experiences and reduced effectiveness of the engagement strategies employed. Additionally, the integration of various engagement elements, such as gamification, progress tracking, and support systems, is often fragmented or incomplete across different platforms.

The rapid advancement of artificial intelligence and machine learning technologies has opened new possibilities for enhancing engagement platforms. These technologies have the potential to enable more adaptive and responsive systems that can analyze user behavior, predict needs, and provide tailored support. However, the effective implementation of these technologies in engagement platforms remains a complex challenge.

Another area of consideration is the balance between automated systems and human interaction in engagement platforms. While automation can provide scalability and consistency, human expertise and empathy are often valuable in addressing nuanced user needs and providing personalized guidance. Finding the right equilibrium between these two elements is an ongoing area of exploration in the field of engagement platform design.

As organizations and individuals increasingly rely on digital platforms for learning, skill development, and task management, there is a growing need for engagement solutions that can effectively support users throughout their journeys. This includes providing timely interventions, maintaining user motivation, and adapting to changing user requirements over time.

The field of engagement platforms continues to evolve, driven by advancements in technology and a deeper understanding of user engagement dynamics. As such, there is ongoing interest in developing more comprehensive, adaptive, and user-centric engagement solutions that can address the multifaceted challenges of maintaining long-term user engagement and facilitating successful outcomes across various domains.

### SUMMARY OF THE INVENTION

Bearing in mind the problems and deficiencies of the prior art, it is therefore an object of the present invention to provide a comprehensive solution to unique, personalized engagement covering the aspects of; Customizable Engagement Plans, Adaptive Messaging, Behavioral Incentives, Balanced Gamification Elements, Enhanced Automated Tutoring and Support, Hybrid Automated and Human Coaching, Granular and Constructive Progress Tracking, Collaborative Coordination, User Management and Process Tracking.

Still other objects and advantages of the invention will in part be obvious and will in part be apparent from the specification.

One aspect of the engagement platform is directed to an engagement platform including a user component having a user interface and user content. The user interface includes customizable engagement plans providing for an individualized learning style. The user interface includes individualized preferences and individualized contexts. The user interface includes adaptive messaging using machine learning based on user feedback, overall usage, and engagement levels achieved. User content of the engagement platform includes diverse behavioral incentives appealing to different motivational drivers including intrinsic rewards, and extrinsic acknowledgements. User content includes balanced gamification offering engaging competitive aspects which provide personal achievement recognition and cater to a broad spectrum of user motivation attributes. User content includes enhanced automated tutoring bridging the gap between generic support and user specific needs through natural language processing and contextually relevant assistance. User content includes hybrid automated coaching tailored to individual needs for automated guidance using AI and LLM's and human interaction. User content includes granular (finely detailed), constructive progress tracking having actionable insights emphasizing detailed constructive feedback.

The engagement platform has a management component including collaborative coordination through just-in-time group formation comprising an online community. The management component includes a user management and process tracking system providing for intervention insight and quick review of individuals by teachers, and process managers and user communication directly with teachers and process managers.

According to an aspect of the present disclosure, an engagement platform is provided. The engagement platform includes a user component having a user interface and user content. The user interface includes adaptive messaging having dynamic communication adjusted through using machine learning based on user feedback, overall usage, and engagement levels achieved. The user content includes diverse behavioral incentives appealing to different motivational drivers including intrinsic rewards and extrinsic acknowledgements, balanced gamification offering engaging competitive aspects which provide personal achievement recognition and cater to a broad spectrum of user motivation attributes, enhanced automated tutoring bridging the gap between generic support and user specific needs through natural language processing and contextually relevant assistance, hybrid automated coaching tailored to individual needs for automated guidance using AI and LLM's and human interaction, and granular, constructive progress tracking having actionable insights emphasizing detailed constructive feedback. The engagement platform also includes a management component having collaborative coordination through just-in-time group formation comprising an online community, and a user management and process tracking system providing for intervention insight and quick review of individuals by teachers and process managers and user communication directly with teachers and process managers.

One aspect of the engagement platform includes service modes such as a stay-engaged assistant (SEA) which operates in three configurable modes. The three configurable service modes allow the system to adapt engagement strategies to the needs of the user and the goals of the program.

The first mode is a state-chart mode whereby administrators or system designers define the engagement flow using a state-chart interface. States represent phases in the engagement journey (e.g., onboarding, active use, lapse, re-engagement). Transitions are triggered by system-detected events (e.g., inactivity, milestone completion) or timers (e.g., time since last interaction). Actions assigned to each transition or state include notifications, rewards, reminders, or escalation to human support. This deterministic framework ensures predictable, programmatic behavior that can be tested, audited, and customized.

The second mode is an agentic AI Mode wherein the system implements an AI agent such as a reinforcement learning or supervised learning model. The AI agent continuously monitor user behavior and context and dynamically adjust engagement tactics, including message tone, frequency, reward structure, or channel. The AI agent learns from performance data, user preferences, and system outcomes to optimize engagement. The AI agents operate independently of predefined rules, focusing on maximizing engagement outcomes over time.

The third mode is a hybrid mode which includes AI-augmented state-chart adaptation. In hybrid mode, the system integrates the AI agent within the state-chart framework, enabling AI-driven adjustment of state-chart parameters (e.g., changing timers, selecting alternate actions, or dynamically skipping states), enabling context-aware modification of transition rules based on detected patterns or predicted user needs, and enabling real-time adaptation of engagement strategies within the deterministic framework, combining the auditability of rules with the personalization of machine learning.

In an example, if the system detects a user's motivation is intrinsic (via behavior analysis), the AI may shorten the reward phase or replace extrinsic rewards with meaningful challenges. If a user is at risk of dropping out, the AI can accelerate escalation to a human coach or introduce a surprise incentive, even if the standard chart would not trigger it yet.

Benefits of the hybrid mode are that the mode combines explainability and control (state charts) with personalization and adaptability (AI), allows for continuous improvement of predefined workflows without sacrificing compliance or predictability, and enables the system to self-tune and optimize over time while maintaining human oversight. According to other aspects of the present disclosure, the engagement platform may include one or more of the following features. The user content may have multi-directional communication with the user interface as well as the management component. The diverse behavioral incentives may include behavioral change apps and gamified environments, offering incentives, and catering to a wide range of motivational drivers from intrinsic rewards to extrinsic acknowledgments. The balanced gamification may balance competitive aspects with personal achievement recognition, catering to a broader spectrum of user motivations. The enhanced automated tutoring may improve this feature with natural language processing and contextually relevant assistance, bridging the gap between generic support and user-specific needs. The hybrid automated coaching may offer automated guidance and human interaction for comprehensive support tailored to user needs. The granular and constructive progress tracking may emphasize detailed, constructive feedback, offering actionable insights for improvement. The collaborative coordination may enhance collaborative efforts through just-in-time group formation and coordination. The user management and process tracking system may enable a process manager or teacher to see where each individual is quickly and if an intervention is needed, and may also allow users to communicate with the manager if problems arise.

One example of use of the engagement platform is in healthcare adherence for patient engagement & compliance monitoring. The engagement platform is deployed in a healthcare context to enhance patient adherence to treatment plans, support chronic condition management, and improve overall wellness outcomes. Another example of use of the engagement platform is in corporate upskilling for employee training & retention. The engagement platform can be used by companies to drive employee learning & development programs, aiming to upskill their workforce in areas like digital literacy, leadership, and compliance.

The above and other objects, which will be apparent to those skilled in the art, are achieved in the present invention which is directed to a software platform in the area of personalized engagement which provides for a personalized user-centric approach through customizable engagement plans, an adaptive messaging mechanism, a diverse incentive mechanism, and a hybrid coaching mechanism, combined with process and progress tracking, for the purpose of prioritizing the users' preferences, goals, and contexts, for meeting objectives and expected outcomes through a fusion of technology and personalized human-centric design which meets individual needs.

### BRIEF DESCRIPTION OF THE DRAWINGS AND TABLES

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 illustrates a block diagram of an engagement platform, according to aspects of the present disclosure.

FIG. 2 depicts a sequence diagram of interactions in a stay-engaged service scenario, according to an embodiment.

FIG. 3 shows a mobile device display presenting a job search tracking interface, according to aspects of the present disclosure.

FIG. 4 illustrates a mobile device interface displaying a job search phase selection screen, according to an embodiment.

FIG. 5 depicts a user interface for selecting a primary challenge in job searching, according to aspects of the present disclosure.

FIG. 6 shows a mobile device interface presenting a video with feedback options, according to an embodiment.

FIG. 7 illustrates a contact tracking table displaying user engagement information, according to aspects of the present disclosure.

FIG. 8 depicts a comparative analysis matrix of various engagement solutions across different platforms, according to an embodiment.

FIG. 9 shows a mobile device interface displaying an automated coach interacting with the user. Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The terms system and platform are used interchangeably to mean a compilation to the instant invention.

Prior to a discussion of the first embodiment of the invention, it should be understood that the features and advantages of the invention are illustrated in terms of a complete and comprehensive package known as an engagement platform.

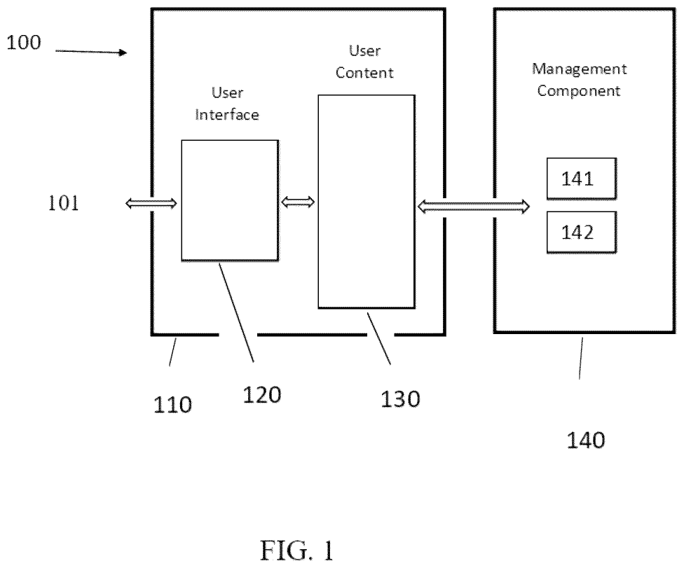

FIG. 1 illustrates a block diagram of an adaptive engagement platform 100 for providing a comprehensive solution for personalized user engagement. The adaptive engagement platform 100 includes a user component 110 and a management component 140. The user component 110 includes a user interface 120 and a user content module 130. The user interface 120 includes a setup interface 121 and an adaptive messaging interface 122. The adaptive messaging interface 122 facilitates dynamic communication with users. In some implementations, the user content module 130 includes multiple specialized modules to enhance user engagement. The user content module 130 includes a behavioral incentives module 131, a gamification module 132, an automated tutoring module 133, a hybrid coaching module 134, and a progress tracking module 135. Each of these modules contribute to different aspects of user engagement and support.

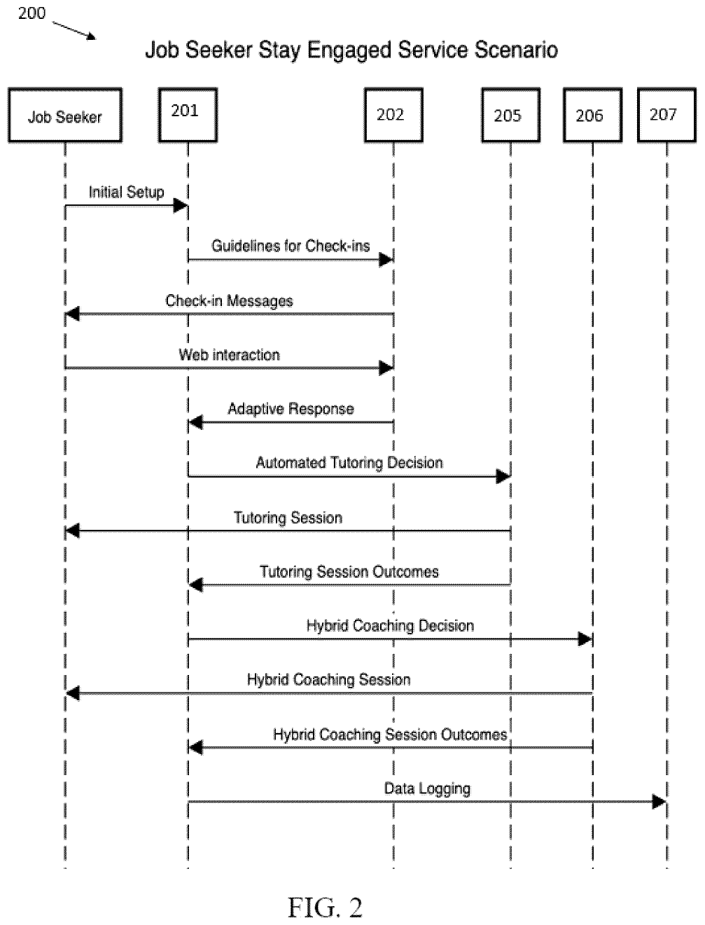

The management component 140 of the adaptive engagement platform 100 includes a coordination module 141 and a user management module 142. These modules facilitate collaborative efforts and user management within the platform. The adaptive engagement platform 100 utilizes various components to support user engagement. As shown in the diagram 200 of FIG. 2, an engagement engine 201 manages overall engagement strategies. A messaging component 202 may handle communication with users. A tutoring component 205 may provide automated learning support. A coaching component 206 may offer hybrid coaching services. A data tracking component 207 may monitor and analyze user interactions and progress.

The adaptive engagement platform 100 may be applied to various scenarios, including a job seeker stay-engaged service. This scenario may demonstrate how the platform adapts to user needs and provides ongoing support throughout a complex process.

The user component 110 of the engagement platform 100 may comprise a user interface 120 and a user content module 130. In some cases, the user interface 120 may facilitate interactions between a user 101 and the engagement platform 100.

The user interface 120 may include a setup interface 121 and an adaptive messaging interface 122. The setup interface 121 may allow a user 101 to input initial preferences and goals. In some implementations, the adaptive messaging interface 122 may utilize machine learning techniques to adjust dynamic communication based on user feedback, overall usage, and engagement levels achieved.

The user content module 130 may contain multiple specialized modules designed to enhance user engagement. These modules may include a behavioral incentives module 131, a gamification module 132, an automated tutoring module 133, a hybrid coaching module 134, and a progress tracking module 135.

In some cases, the behavioral incentives module 131 may provide a range of motivational drivers. The behavioral incentives module 131 may include intrinsic rewards and extrinsic acknowledgements to cater to different user preferences and motivations.

The gamification module 132 may offer engaging competitive aspects within the engagement platform 100. In some implementations, the gamification module 132 may provide personal achievement recognition to users. This approach may cater to a broader spectrum of user motivations, balancing competitive elements with individual accomplishments.

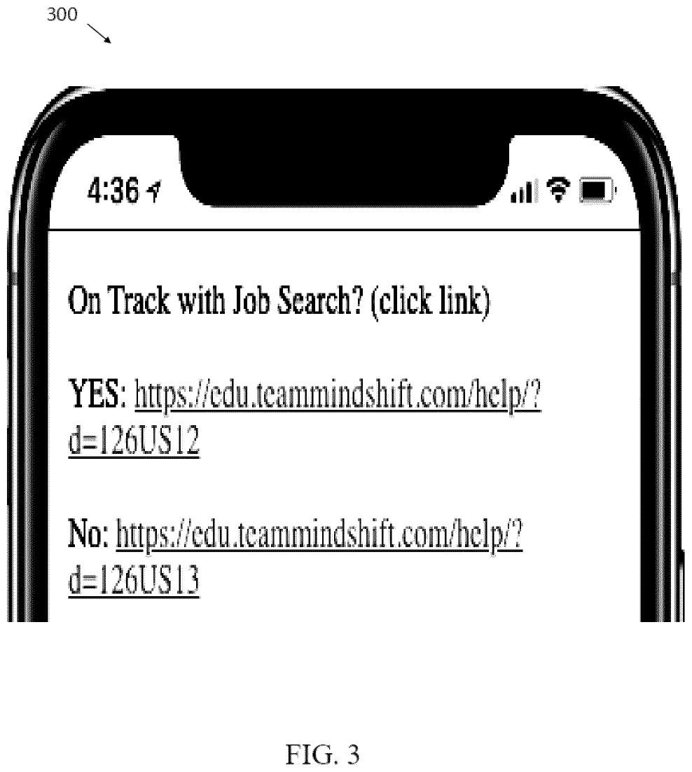

FIG. 3 is a display portion 300 showing an example of how the adaptive messaging interface 122 may appear on a mobile device display. The interface may present a question to the user 101 regarding their progress in a job search scenario. The interface may include an affirmative response link 126US12 labeled “YES:” and a negative response link 126US13 labeled “NO:”. These links may direct users to different paths within the engagement platform 100 based on their response.

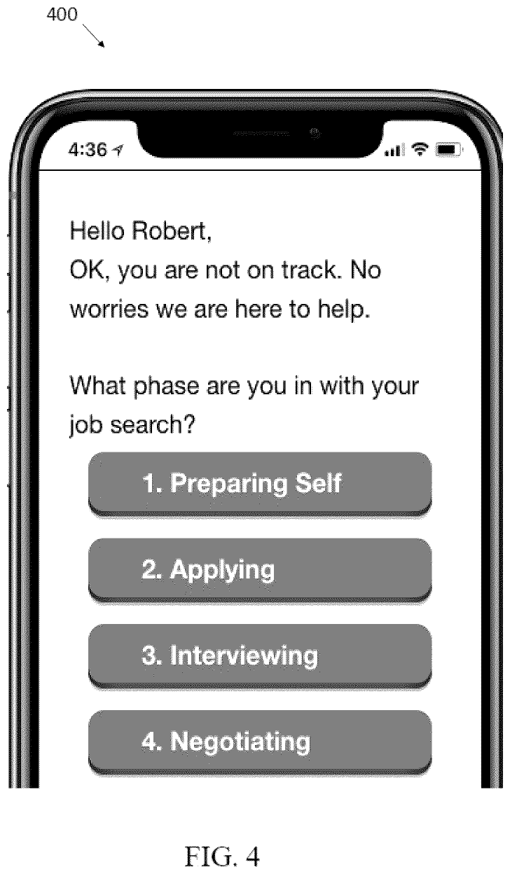

FIG. 4 is a display portion 400 showing an example of the user interface 120, where the engagement platform 100 may present a job search phase selection screen to the user 101. This interface may allow users to specify their current stage in the job search process, facilitating more targeted support and engagement.

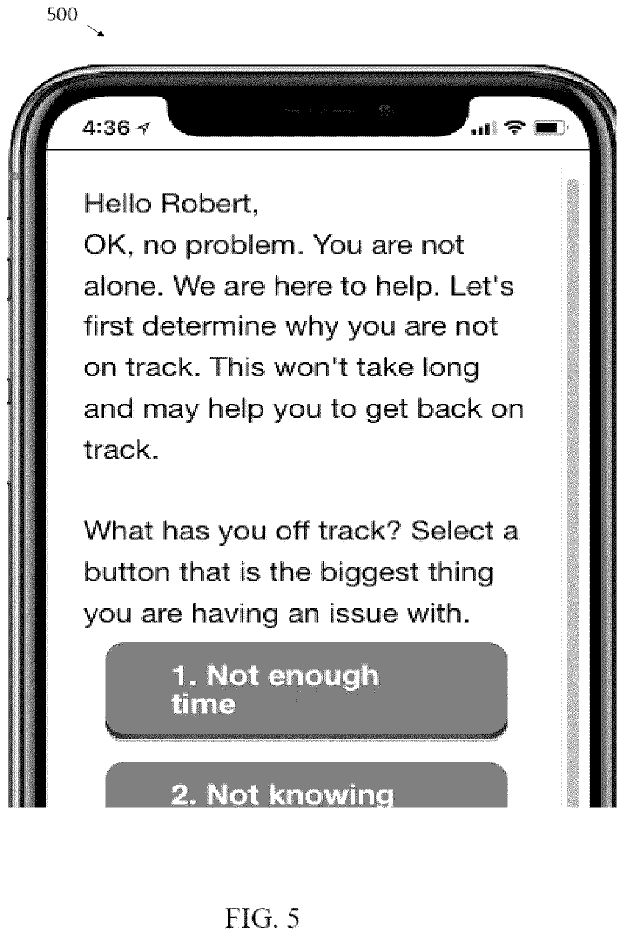

FIG. 5 is a display portion 500 showing, the user interface 120 may present options for users to identify challenges they are facing. The interface may include a time selection button 1 labeled “Not enough time” and a knowledge selection button 2 labeled “Not knowing”. These options may help the engagement platform 100 tailor its support to the specific needs of the user 101.

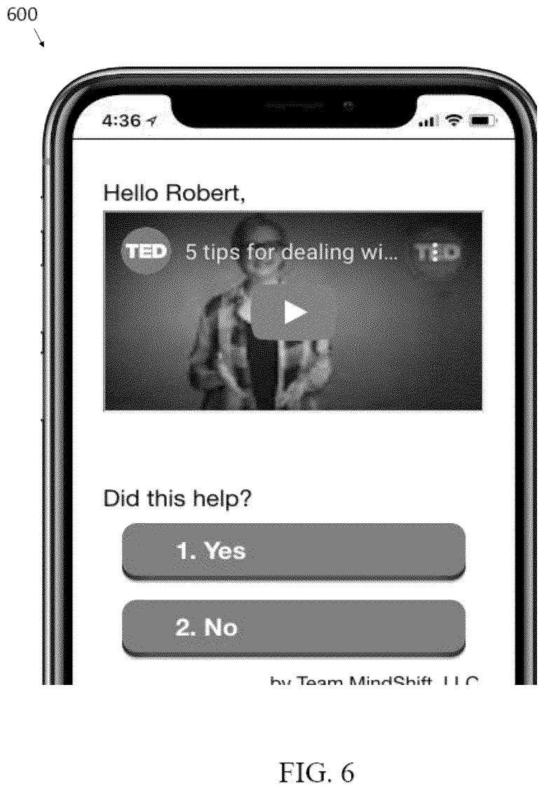

FIG. 6 is a display portion 600 showing how the user content module 130 may deliver educational content to users. In this example, the interface presents a video along with feedback options, allowing users to indicate whether the content was helpful.

The user component 110 may work in conjunction with other components of the engagement platform 100, such as the engagement engine 201, messaging component 202, tutoring component 205, and coaching component 206, to provide a comprehensive and personalized user experience.

The user interface 120 of the engagement platform 100 may comprise multiple components designed to facilitate user interaction and engagement. In some cases, the user interface 120 may include a setup interface 121 and an adaptive messaging interface 122.

The setup interface 121 may allow users to input initial preferences and goals. In some implementations, the setup interface 121 may present a series of questions or prompts to gather information about the user's objectives, communication preferences, and current status. For example, in a job seeker scenario, the setup interface 121 may ask users to specify their desired job type, preferred industry, and current stage in the job search process.

The adaptive messaging interface 122 may facilitate dynamic communication with users based on their interactions and progress. In some cases, the adaptive messaging interface 122 may utilize machine learning techniques to adjust message content, frequency, and tone. For example, the adaptive messaging interface 122 may analyze user responses and engagement levels to determine the most effective communication strategy for each individual user.

FIG. 3 is a display portion 400 showing an example of how the adaptive messaging interface 122 may appear on a mobile device display. The interface may present a question to the user regarding their progress in a job search scenario. The interface may include an affirmative response link 126US12 labeled “YES:” and a negative response link 126US13 labeled “NO:”. These links may direct users to different paths within the engagement platform 100 based on their response.

The user interface 120 may adapt based on user responses. For example, if a user selects the negative response link 126US13, the engagement platform 100 may present a follow-up screen as shown in FIG. 4. This screen may allow users to specify their current phase in the job search process, enabling the platform to provide more targeted support and guidance.

The user interface 120 may also incorporate elements to identify specific challenges users may be facing. As illustrated in FIG. 5, the interface may present options such as the time selection button 1 labeled “Not enough time” and the knowledge selection button 2 labeled “Not knowing”. These options may help the engagement platform 100 tailor its support to address the specific needs of each user.

In some cases, the user interface 120 may integrate with the user content module 130 to deliver educational content and gather feedback. FIG. 6 demonstrates how the interface may present a video along with feedback options, allowing users to indicate whether the content was helpful. This feedback mechanism may enable the engagement platform 100 to continuously refine and improve the content delivered to users.

The adaptive nature of the user interface 120 may extend to various aspects of user interaction. For example, the messaging component 202 may adjust the frequency and timing of check-in messages based on user preferences and engagement patterns. The tutoring component 205 and coaching component 206 may utilize the user interface 120 to deliver personalized learning experiences and support.

In some implementations, the user interface 120 may also provide access to progress tracking features. Users may be able to view their progress, set goals, and receive personalized recommendations through the interface. This integration of progress tracking within the user interface 120 may help maintain user engagement and motivation throughout their journey on the engagement platform 100.

The user content module 130 of the engagement platform 100 may comprise multiple specialized modules designed to enhance user engagement and support. These modules may include a behavioral incentives module 131, a gamification module 132, an automated tutoring module 133, a hybrid coaching module 134, and a progress tracking module 135.

In some cases, the behavioral incentives module 131 may provide a range of motivational drivers to encourage user engagement. The behavioral incentives module 131 may offer both intrinsic rewards and extrinsic acknowledgements to cater to different user preferences. For example, the behavioral incentives module 131 may award virtual badges for completing certain tasks or reaching milestones in a job search process.

The gamification module 132 may incorporate engaging competitive aspects within the engagement platform 100. In some implementations, the gamification module 132 may create leaderboards or challenge systems that allow users to compete with themselves or others in a constructive manner. The gamification module 132 may also provide personal achievement recognition, balancing competitive elements with individual accomplishments to appeal to a broader spectrum of user motivations.

The automated tutoring module 133 may utilize natural language processing techniques to provide contextually relevant assistance to users. In some cases, the automated tutoring module 133 may analyze user inputs and progress to generate personalized learning content. For example, if a user indicates difficulty with resume writing through the user interface 120, the automated tutoring module 133 may provide targeted tutorials and examples specific to resume creation.

The hybrid coaching module 134 may combine automated guidance with human interaction to provide comprehensive support tailored to user needs. In some implementations, the hybrid coaching module 134 may use automated systems to handle routine inquiries and provide initial guidance, while escalating more complex issues to human coaches. For instance, the hybrid coaching module 134 may automatically suggest interview preparation techniques based on a user's job search phase, as indicated through the interface shown in FIG. 4, while offering the option to schedule a personalized coaching session for in-depth interview strategy discussions.

The progress tracking module 135 may provide granular, constructive feedback with actionable insights to users. In some cases, the progress tracking module 135 may monitor user activities and achievements across various aspects of their engagement with the platform. The progress tracking module 135 may generate detailed reports highlighting areas of improvement and suggesting specific actions to enhance progress. For example, the progress tracking module 135 may analyze a user's job application history and provide feedback on application quality, along with recommendations for improving future applications.

In some implementations, the user content modules may work in conjunction with other components of the engagement platform 100. For instance, the messaging component 202 may utilize insights from the progress tracking module 135 to send targeted messages through the adaptive messaging interface 122. Similarly, the tutoring component 205 and coaching component 206 may leverage data from the behavioral incentives module 131 and gamification module 132 to tailor their approaches to individual user motivations and preferences.

The integration of these user content modules within the engagement platform 100 may create a comprehensive and personalized user experience. By addressing various aspects of user engagement, from motivation and learning to progress tracking and personalized support, the user content module 130 may contribute to the overall effectiveness of the engagement platform 100 in supporting users through complex processes such as job searching or skill development.

The management component 140 of the engagement platform 100 may include a coordination module 141 and a user management module 142. These modules may work together to facilitate collaborative efforts and user management within the platform.

In some cases, the coordination module 141 may enable just-in-time group formation for an online community. The coordination module 141 may analyze user data and engagement patterns to identify opportunities for collaboration among users. For example, the coordination module 141 may group job seekers with similar career interests or at similar stages in their job search process. This dynamic group formation may enhance peer support and knowledge sharing within the engagement platform 100.

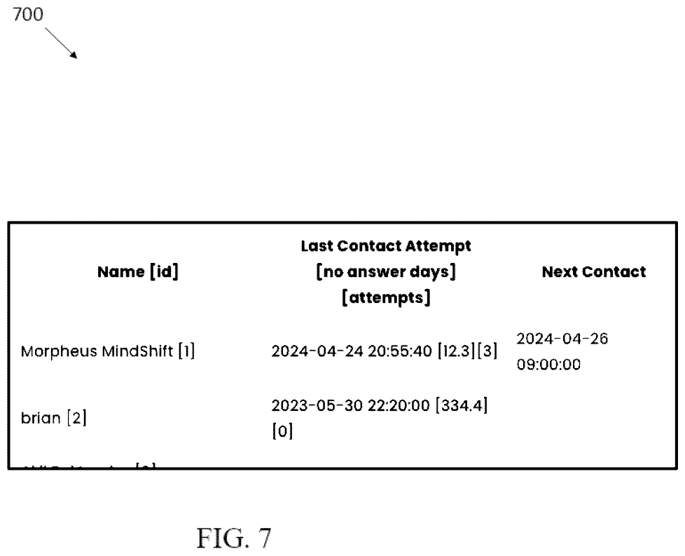

The user management module 142 may allow for intervention insight and quick review of individuals by teachers and process managers. In some implementations, the user management module 142 may provide a dashboard interface for monitoring user progress and engagement levels. This interface may be similar to the contact tracking table 700 shown in FIG. 7, which displays information about contact attempts, including user names, timestamps of last contact attempts, and scheduled next contact times.

The user management module 142 may analyze user interactions with various components of the engagement platform 100, such as the user interface 120 and the user content module 130. Based on this analysis, the user management module 142 may generate alerts or recommendations for intervention when users show signs of disengagement or face persistent challenges.

For example, if a user consistently selects the negative response link in the adaptive messaging interface 122, the user management module 142 may flag this user for additional support. Teachers or process managers may then use the insights provided by the user management module 142 to offer targeted assistance or adjust the user's engagement plan.

In some cases, the management component 140 may integrate with other components of the engagement platform 100 to enhance its functionality. For instance, the coordination module 141 may work with the messaging component 202 to facilitate communication within formed groups. Similarly, the user management module 142 may leverage data from the progress tracking module 135 to provide comprehensive insights into user performance and engagement.

The management component 140 may play a crucial role in ensuring the effectiveness of the engagement platform 100 by enabling collaborative learning opportunities and providing tools for proactive user support and intervention.

The engagement platform 100 may facilitate complex interactions between various components and modules to provide personalized support for users. In some cases, these interactions may be illustrated through a job seeker scenario, demonstrating how the platform adapts to user needs and provides ongoing engagement.

The user component 110 may serve as the primary interface between the user 101 and the engagement platform 100. In some implementations, the setup interface 121 within the user interface 120 may initiate the engagement process by collecting initial user preferences and goals. For example, a job seeker may input their desired job type, industry preferences, and current stage in the job search process through the setup interface 121.

The engagement engine 201 may analyze this initial input to develop a customized engagement plan. In some cases, the engagement engine 201 may communicate with the user management module 142 to establish baseline metrics for tracking user progress.

The adaptive messaging interface 122 may play a central role in maintaining ongoing communication with the user 101. In some implementations, as illustrated in FIG. 3, the adaptive messaging interface 122 may present check-in messages to users, such as “On Track with Job Search? (click link)”. The user 101 may respond using the affirmative response link 126US12 or the negative response link 126US13.

Based on the user's response, the messaging component 202 may trigger different engagement pathways. For example, if the user 101 selects the negative response link 126US13, the user interface 120 may present a follow-up screen as shown in FIG. 4, allowing the user 101 to specify their current phase in the job search process.

The user content module 130 may work in conjunction with the user interface 120 to deliver personalized content and support. In some cases, the behavioral incentives module 131 and the gamification module 132 may collaborate to provide motivational elements tailored to the user's preferences and engagement patterns.

The automated tutoring module 133 may interact with the tutoring component 205 to provide targeted learning experiences. For instance, if a user indicates difficulty with time management through the time selection button 1 in FIG. 5, the automated tutoring module 133 may generate relevant tutorials or exercises.

The hybrid coaching module 134 may work with the coaching component 206 to offer a combination of automated guidance using AI and LLM's and human interaction. In some implementations, the hybrid coaching module 134 may analyze user progress data from the progress tracking module 135 to determine when to escalate support to human coaches.

The data tracking component 207 may continuously monitor user interactions and progress across various platform components. This data may be used by the progress tracking module 135 to generate detailed insights and recommendations for the user 101.

The management component 140 may oversee the overall functioning of the engagement platform 100. In some cases, the coordination module 141 may facilitate group formation based on user data and engagement patterns. The user management module 142 may provide intervention insights for teachers or process managers, as illustrated by the contact tracking table 700 in FIG. 7.

Throughout the engagement process, the various components and modules may communicate and adapt based on user interactions and progress. For example, if a user consistently engages with certain types of content, the engagement engine 201 may adjust the user's engagement plan accordingly, potentially modifying the frequency of check-ins through the messaging component 202 or suggesting new learning resources through the automated tutoring module 133.

This interconnected system of components and modules may allow the engagement platform 100 to provide a comprehensive and adaptive support structure for users, as they navigate complex processes such as job searching or skill development.

The user interface 120 of the engagement platform 100 may provide various examples of how users interact with the system, particularly in the context of a job search scenario. In some cases, these interfaces may be displayed on a mobile device, offering users convenient access to the platform's features.

FIG. 3 illustrates an example of a job search tracking interface that may be presented to users through the adaptive messaging interface 122. The interface may display a question at the top of the screen, asking “On Track with Job Search? (click link)”. Below this question, the interface may provide two response options: the affirmative response link 126US12 labeled “YES:” and the negative response link 126US13 labeled “NO:”. Each response option may include a corresponding web link that directs users to different paths within the engagement platform 100.

In some implementations, the user's response to this tracking question may trigger different engagement pathways within the platform. For example, if a user selects the negative response link 126US13, the engagement platform 100 may present a follow-up screen to gather more specific information about the user's current status.

FIG. 4 demonstrates an example of a job search phase selection screen that may be displayed to users. This interface may be part of the user interface 120 and may appear after a user indicates they are not on track with their job search. The screen may present a personalized greeting, such as “Hello Robert”, followed by a message acknowledging the user's response and offering support. The main content area of this interface may pose the question “What phase are you in with your job search?” followed by four selectable options presented as buttons. These options may include “1. Preparing Self”, “2. Applying”, “3. Interviewing”, and “4. Negotiating”.

The phase selection screen may allow the engagement platform 100 to tailor its support and resources based on the user's specific stage in the job search process. In some cases, the user's selection may inform the content delivered by the user content module 130 and the type of support offered by the automated tutoring module 133 or the hybrid coaching module 134.

FIG. 5 illustrates an example of a challenge selection interface that may be presented to users through the user interface 120. This screen may appear as part of the platform's effort to identify specific challenges users may be facing in their job search process. The interface may display a message addressing the user and explaining that determining why they are not on track may help get them back on track. Below this message, the interface may present two selectable options: the time selection button 1 labeled “Not enough time” and the knowledge selection button 2 labeled “Not knowing”.

The challenge selection interface may allow users to pinpoint their primary obstacle in the job search process. In some implementations, the user's selection may inform the engagement engine 201 about which resources or support mechanisms to prioritize for that particular user. For example, if a user selects the time selection button 1, the engagement platform 100 may focus on providing time management strategies or more efficient job search techniques.

FIG. 6 demonstrates how the user interface 120 may present educational content to users as part of the engagement process. The interface may display a video with a play button overlay to begin the video. Below the video, the interface may include a feedback prompt asking “Did this help?” with two response options: “1. Yes” and “2. No”. This feedback mechanism may allow the engagement platform 100 to gauge the effectiveness of the content provided and potentially adjust future content recommendations based on user responses.

These user interface examples may illustrate how the engagement platform 100 may adapt to user inputs and provide personalized support throughout the job search process. By offering targeted questions, phase-specific guidance, and relevant educational content, the platform may aim to maintain user engagement and provide tailored assistance based on individual needs and challenges.

The engagement platform 100 may include mechanisms for content presentation and user feedback to enhance the learning experience and engagement of users. In some cases, these mechanisms may be implemented through various components of the user interface 120 and the user content module 130.

FIG. 6 illustrates an example of how the user interface 120 may present educational content to users. The interface may display a video with a play button overlay. This video content may be part of the user content module 130, potentially delivered through the automated tutoring module 133 or the hybrid coaching module 134.

In some implementations, the video content may be tailored to the user's specific needs or challenges, as identified through earlier interactions with the engagement platform 100. For example, if a user has indicated difficulty with time management by selecting the time selection button 1 in FIG. 5, the platform may present a video offering tips for managing time during a job search.

Below the video presentation, the user interface 120 may include a feedback mechanism. As shown in FIG. 6, the interface may prompt users with the question “Did this help?” followed by two response options: “1. Yes” and “2. No”. This feedback system may allow the engagement platform 100 to gauge the effectiveness of the content provided to users.

In some cases, the user's feedback may be processed by the engagement engine 201 to inform future content recommendations. For example, if a user consistently provides positive feedback for video content, the platform may prioritize video-based learning materials for that user in subsequent interactions.

The engagement platform 100 may also include an AI Tutor Bot for personalized student assistance. In some implementations, the AI Tutor Bot may be integrated into the automated tutoring module 133. The AI Tutor Bot may analyze user interactions, progress, and feedback to provide tailored guidance and support.

For instance, based on a user's response to the video content in FIG. 6, the AI Tutor Bot may generate follow-up questions or provide additional resources to reinforce the learning experience. The AI Tutor Bot may also adapt its communication style and content delivery based on the user's preferences and learning patterns observed over time.

FIG. 7 demonstrates another aspect of content presentation and feedback tracking within the engagement platform 100. The figure shows a contact tracking table 700 that may be part of the user management module 142. The contact tracking table 700 may display information about contact attempts, including user names, timestamps of last contact attempts, and scheduled next contact times.

In some cases, the contact tracking table 700 may be used by the messaging component 202 to manage and schedule communications with users. The table may also provide insights to process managers or teachers about user engagement levels and the effectiveness of different communication strategies.

For example, the contact tracking table 700 in FIG. 7 shows an entry for a user named “Morpheus MindShift [1]” with multiple contact attempts and a scheduled next contact time. This information may help the engagement platform 100 maintain consistent communication with users and identify those who may require additional support or intervention.

The combination of content presentation mechanisms, feedback systems, and engagement tracking tools may allow the engagement platform 100 to provide a personalized and adaptive learning experience for users. By continuously gathering and analyzing user feedback and engagement data, the platform may refine its content delivery and support strategies to better meet the needs of individual users.

The engagement platform 100 may offer several advantages when compared to existing solutions in the market. In some cases, the engagement platform 100 may provide a more comprehensive and personalized approach to user engagement and support.

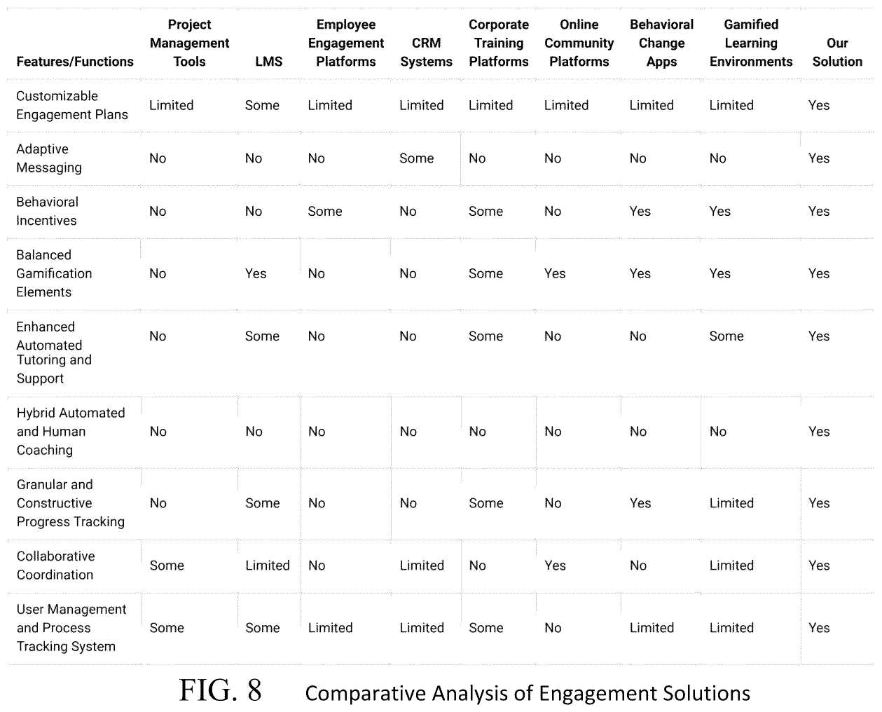

FIG. 8 illustrates a comparative analysis of the engagement platform 100 with various existing solutions, including Project Management Tools, Learning Management Systems (LMS), Employee Engagement Platforms, CRM Systems, Corporate Training Platforms, Online Community Platforms, Behavioral Change Apps, and Gamified Learning Environments.

The comparative analysis may highlight several features of the engagement platform 100 that may set it apart from existing solutions. In some cases, the engagement platform 100 may offer customizable engagement plans through the user component 110 and the management component 140. The adaptive messaging interface 122 may provide dynamic communication adjusted through machine learning based on user feedback and engagement levels.

The user content module 130 of the engagement platform 100 may include diverse behavioral incentives through the behavioral incentives module 131, appealing to different motivational drivers. The gamification module 132 may offer balanced gamification elements, providing personal achievement recognition and catering to a broad spectrum of user motivation attributes.

In some implementations, the automated tutoring module 133 may provide enhanced automated tutoring and support, bridging the gap between generic support and user-specific needs through natural language processing and contextually relevant assistance. The hybrid coaching module 134 may offer a combination of automated guidance using AI and LLM's and human interaction, providing comprehensive support tailored to user needs.

The progress tracking module 135 may provide granular and constructive progress tracking, offering actionable insights and emphasizing detailed constructive feedback. This feature may not be as developed in existing solutions, as shown in the comparative analysis in FIG. 8. In the analysis, “yes” indicates that the feature is fully integrated and extensively supported within the solution. It suggests a robust implementation that is central to the functionality of the system, offering comprehensive and detailed support or capability in this area. “Some” signifies that the feature is present but not as extensively or robustly supported as it may be in the systems marked “yes”. This may mean that while the feature exists, it is not customizable to the extent found in more advanced systems, or it may lack the depth and breadth if integration seen in the solution. “Limited” denoted that the feature is available but with significant restrictions or in a very basic form. This indicated minimal functionality, providing only the essential aspects without broader integration or depth. The feature is typically underdeveloped, offering only foundational support that may not be effective form more complex or customizes needs. No indicated the absence of the feature in the solution. This means the solution does not support or include this functionality in any form highlighting a significant gap compared to other systems where this feature may be integral.

The coordination module 141 may enhance collaborative efforts through just-in-time group formation and coordination, a feature only partially addressed by some project management tools and online community platforms. The user management module 142 may provide a user management and process tracking system, enabling quick review of individuals and intervention insights.

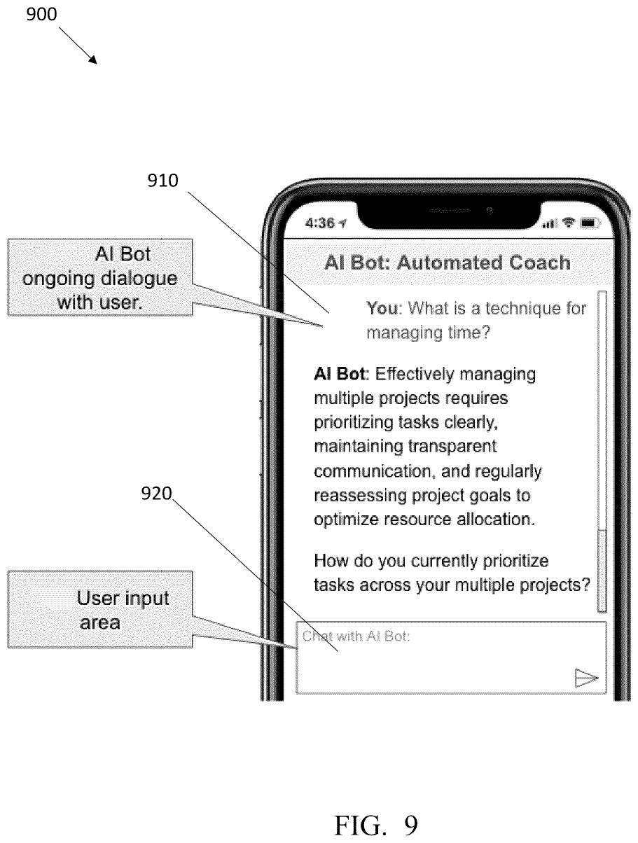

FIG. 9 shows a mobile device interface 900 displaying an automated coach interacting with a user. The mobile device interface 900 includes a dialogue area 910 for display of the conversation and a user input area 920 to display the user entry text. The automated coach may implement any combination of AI and LLMs.

In some cases, the engagement platform 100 may utilize a vector database to store and retrieve course content for dynamic responses. This feature may allow the engagement platform 100 to provide more contextually relevant and personalized content to users compared to traditional content delivery methods used in existing solutions.

The engagement engine 201, in conjunction with the messaging component 202, tutoring component 205, coaching component 206, and data tracking component 207, may work together to create a more integrated and adaptive user experience compared to existing solutions that may have these features implemented separately or in a limited capacity.

The user interface 120, as demonstrated in FIG. 3, FIG. 4, FIG. 5, and FIG. 6, may provide a more intuitive and responsive interaction experience compared to some existing platforms. For example, the affirmative response link 126US12 and negative response link 126US13 in FIG. 3 may allow for quick user feedback, which may then trigger more targeted support or content delivery.

The contact tracking table shown in FIG. 7 may represent a more comprehensive approach to user engagement tracking compared to some existing solutions. This feature, as part of the user management module 142, may allow for more proactive and personalized user support.

One aspect of the engagement platform includes service modes such as a stay-engaged assistant (SEA) which operates in three configurable modes. The three configurable service modes allow the system to adapt engagement strategies to the needs of the user and the goals of the program.

The first mode is a state-chart mode whereby administrators or system designers define the engagement flow using a state-chart interface. States represent phases in the engagement journey (e.g., onboarding, active use, lapse, re-engagement). Transitions are triggered by system-detected events (e.g., inactivity, milestone completion) or timers (e.g., time since last interaction). Actions assigned to each transition or state include notifications, rewards, reminders, or escalation to human support. This deterministic framework ensures predictable, programmatic behavior that can be tested, audited, and customized.

The second mode is an agentic AI Mode wherein the system implements an AI agent such as a reinforcement learning or supervised learning model. The AI agent continuously monitor user behavior and context and dynamically adjust engagement tactics, including message tone, frequency, reward structure, or channel. The AI agent learns from performance data, user preferences, and system outcomes to optimize engagement. The AI agents operate independently of predefined rules, focusing on maximizing engagement outcomes over time.

The third mode is a hybrid mode which includes AI-augmented state-chart adaptation. In hybrid mode, the system integrates the AI agent within the state-chart framework, enabling AI-driven adjustment of state-chart parameters (e.g., changing timers, selecting alternate actions, or dynamically skipping states), enabling context-aware modification of transition rules based on detected patterns or predicted user needs, and enabling real-time adaptation of engagement strategies within the deterministic framework, combining the auditability of rules with the personalization of machine learning.

In an example, if the system detects a user's motivation is intrinsic (via behavior analysis), the AI may shorten the reward phase or replace extrinsic rewards with meaningful challenges. If a user is at risk of dropping out, the AI can accelerate escalation to a human coach or introduce a surprise incentive, even if the standard chart would not trigger it yet.

Benefits of the hybrid mode are that the mode combines explainability and control (state charts) with personalization and adaptability (AI), allows for continuous improvement of predefined workflows without sacrificing compliance or predictability, and enables the system to self-tune and optimize over time while maintaining human oversight.

One aspect of the engagement platform is directed to a non-transitory computer-readable medium storing instructions that, when executed by a processor, cause the processor to perform operations for an engagement platform. The operations include presenting a user interface for receiving user input and generating adaptive messaging based on the user input, wherein the adaptive messaging is dynamically adjusted using machine learning based on user feedback, overall usage, and engagement levels achieved. The operations include providing user content including diverse behavioral incentives, balanced gamification elements, enhanced automated tutoring, and hybrid automated coaching, implementing granular, constructive progress tracking; and managing user engagement through a user management and process tracking system. The diverse behavioral incentives may include intrinsic rewards and extrinsic acknowledgements catering to different user motivations. The operations may include use of a plurality of service modes. The service modes include a state-chart mode whereby administrators or system designers define the engagement flow using a state-chart interface, an agentic AI Mode wherein the engagement platform implements an AI agent such as a reinforcement learning or supervised learning model; and a hybrid mode including AI-augmented state-chart adaptation wherein the engagement platform integrates the AI agent within the state-chart framework. The enhanced automated tutoring uses natural language processing to provide contextually relevant assistance. The hybrid automated coaching may combine automated guidance using AI and LLM's with human interaction for personalized support. The granular, constructive progress tracking generates actionable insights and provides detailed feedback to users.

In summary, the comparative analysis may suggest that the engagement platform 100 offers a more integrated, personalized, and adaptive approach to user engagement and support compared to many existing solutions in the market. The combination of features and modules within the engagement platform 100 may provide a more comprehensive solution for complex task execution, project management, and skill acquisition.

Referring now to the drawing FIG. 1, a block diagram shows an engagement platform 100 and its components. In the platform 100, a user 101 interfaces with a user component 110. The user component 110 includes a user interface 120 and user content 130, a feature central to the platform.

The engagement platform 100 including a user component 110 having a user interface 120 and user content 130. The user interface 120 includes adaptive messaging 122 having dynamic communication adjusted through using machine learning based on user feedback, overall usage, and engagement levels achieved. User content 130 of the engagement platform 100 includes diverse behavioral incentives 131 appealing to different motivational drivers including intrinsic rewards, and extrinsic acknowledgements. User content includes balanced gamification 132 offering engaging competitive aspects which provide personal achievement recognition and cater to a broad spectrum of user motivation attributes. User content includes enhanced automated tutoring 133 bridging the gap between generic support and user specific needs through natural language processing and contextually relevant assistance. User content 130 includes hybrid automated coaching 134 tailored to individual needs for automated guidance using AI and LLM's and human interaction. User content 130 includes granular, constructive progress tracking 135 having actionable insights emphasizing detailed constructive feedback.

The engagement platform 100 has a management component 140 including collaborative coordination 141 through just-in-time group formation comprising an online community. The management component 140 includes a user management and process tracking system 142 providing for intervention insight and quick review of individuals by teachers, and process managers and user communication directly with teachers and process managers.

User Content has multi-directional communication with the user interface 120 as well as the management component 140. On the engagement platform 100, the diverse behavioral incentives 131 includes behavioral change apps and gamified environments, offering incentives, and catering to the wide range of motivational drivers as does platform, from intrinsic rewards to extrinsic acknowledgments. Many platforms use gamification. The engagement platform 100 balances competitive aspects with personal achievement recognition, catering to a broader spectrum of user motivations. The platform improves this feature with natural language processing and contextually relevant assistance, bridging the gap between generic support and user-specific needs.

Hybrid Automation and Human Coaching 134—Unlike the compared platforms, the platform offers automated guidance using AI and LLM's and human interaction for comprehensive support tailored to user needs. Granular and Constructive Progress Tracking 135—While some LMS and apps provide some level of progress tracking, the platform emphasizes detailed, constructive feedback, offering actionable insights for improvement, a feature not as developed in existing solutions. Collaborative Coordination 141—The platform enhances collaborative efforts through just-in-time group formation and coordination, a feature only partially addressed by some project management tools and online community platforms.

The user management and process tracking system 142 enables a process manager or teacher. to see where each individual is quickly and if an intervention is needed. It will also allow users to communicate with the manager if problems do arise.

FIG. 2 shows a specific example of a job seeker stay-engaged service scenario. Job seekers engage in a series of activities from the initiation to the termination of their job search. Job seeker activities include:
1. Defining Job Preferences: Job seekers specify the type of positions they are interested in.
2. Searching for Opportunities: They explore and identify job openings that match their criteria.
3. Application Process: Job seekers prepare applications and submit them to prospective employers.
4. Follow-up Actions: They engage in follow-up activities, including interview preparation and responding to offers.
5. Negotiation and Decision Making: Job seekers negotiate job terms and make final decisions.

A job seeker might navigate through the support engagement platform as follows:

### Job Seeker 101 to Component 121 (Initial Setup):

a. The Job Seeker 101 inputs their job search goals and communication preferences into component 121.
b. Component 121 records these preferences and sets the parameters for communications.

### Component 121 to Component 122 (Guidelines for Check-Ins):

a. Component 121 sends guidelines to component 122 regarding the frequency and content of check-in messages based on the job seeker's preferences and goals.

### Component 122 to Job Seeker 101 (Check-In Messages):

a. Component 122 sends a check-in message to the job seeker 101 asking about their progress. The job seeker 101 responds with a ‘Yes’ or ‘No.’

### Job Seeker to Component 122 (Web Interaction):

a. Depending on the job seeker's response, Component 122 directs them to a web page that further engages them with clarification questions or resources. This interaction is guided through a response tree.

### Component 122 to Component 121 (Adaptive Response):

a. Component 122 informs component 121 about the job seeker's responses and interactions from the web page.

### Component 121 to Component 133 (Automated Tutoring Decision):

a. If the engagement engine, through analysis and user interaction, identifies a need for additional guidance, component 121 directs Component 133 to provide automated tutoring to the job seeker.

### Component 133 to Job Seeker (Tutoring Session):

a. Component 133 conducts an automated tutoring session based on the specific needs identified.

### Component 121 to Component 134 (Hybrid Coaching Decision);

a. Similarly, component 121 may direct component 134 to initiate hybrid coaching if further personalized support is needed.

### Component 134 to Job Seeker (Hybrid Coaching Session):

a. Component 134 provides a hybrid coaching session combining automated advice with human expertise.

### Feedback Loop to Component 121:

a. Both component 133 and component 134 report back to component 121 regarding the outcomes of their sessions, which informs future interactions and adjustments in the engagement plan.

### Component 121 to Component 135 (Data Logging):

a. Component 121 sends data on the job seeker's interactions and progress to component 135 for tracking and analysis.

Examining the job seeker scenario further, the stay-engaged service enhances this process by offering personalized support tailored to the individual's goals and communication preferences, as follows:

Goal Specification: The job seeker interacts with component 121 to define their job search goals (e.g., applying to at least 5 jobs per week) and set their preferred modes of communication.

Progress Check-ins: component 122 sends periodic check-in messages based on guidelines from component 121. These messages ask the job seeker about their progress, to which they can respond with simple ‘Yes’ or ‘No’ answers. Depending on the response, the job seeker is directed to a web page that offers further clarification questions or resources, guiding them through a response tree that adapts based on their input.

Data Tracking: All interactions, including clicks and activities on the web page, are recorded by component 135 to refine future interactions and provide insights.

Via component 134, the Automated Tutoring and Hybrid Coaching, if the engagement engine, guided by interactions and component 121 insights, identifies a need, the job seeker may be directed to component 133 for automated tutoring.

Similarly, component 134 may provide hybrid coaching, combining automated advice with human expertise to offer tailored support.

FIGS. 3 through 7 are screenshots of a mobile device showing specific examples set forth in FIG. 2. of how the interaction with the support engagement platform appears on the mobile device.

Referring to Table 1, there is shown a comprehensive comparative analysis with existing solutions.

In the pursuit of an effective engagement solution for complex task execution, project management, and skill acquisition, a comprehensive comparative analysis is essential. The comparative analysis goes beyond project management tools and Learning Management Systems (LMS) to encompass a broader spectrum of engagement platforms, each with distinct offerings yet common limitations in providing personalized, adaptive support for task and skill mastery.

FIG. 8 includes a comprehensive gap analysis to such packages as Project Management Tools, LMS, Employee Engagement Platforms, Crew Resource Management (CRM) Systems, Corporate Training Platforms, Online Community Platforms, Behavioral Change Applications, and Gamified Learning Environments.

One example of use of the engagement platform is in healthcare adherence for patient engagement & compliance monitoring. The engagement platform is deployed in a healthcare context to enhance patient adherence to treatment plans, support chronic condition management, and improve overall wellness outcomes. Another example of use of the engagement platform is in corporate upskilling for employee training & retention. The engagement platform can be used by companies to drive employee learning & development programs, aiming to upskill their workforce in areas like digital literacy, leadership, and compliance.

In some embodiments the method or methods described above may be executed or carried out by a computing system including a tangible computer-readable storage medium, also described herein as a storage machine, which holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of the platform is much broader than presented by the claim. It is intended that broader claims will be submitted in an application that claims the benefit of priority from this application.

While the platform has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which the platform pertains and which fall within the limits of the appended claims.

1. An engagement platform, comprising:
a user component having a user interface and user content, wherein the user interface includes adaptive messaging having dynamic communication adjusted through using machine learning based on user feedback, overall usage, and engagement levels achieved, and wherein the user content includes diverse behavioral incentives appealing to different motivational drivers including:
intrinsic rewards and extrinsic acknowledgements;
balanced gamification offering engaging competitive aspects which provide personal achievement recognition and cater to a broad spectrum of user motivation attributes;
enhanced automated tutoring bridging the gap between generic support and user specific needs through natural language processing and contextually relevant assistance;
hybrid automated coaching; and
constructive progress tracking having actionable insights emphasizing detailed constructive feedback; and
a management component having collaborative coordination through just-in-time group formation comprising an online community, and a user management and process tracking system providing for intervention insight and quick review of individuals by teachers and process managers and user communication directly with teachers and process managers.

2. The engagement platform of claim 1, wherein the user content has multi-directional communication with the user interface and the management component.

3. The engagement platform of claim 2, wherein the diverse behavioral incentives include behavioral change apps and gamified environments offering incentives catering to a wide range of motivational drivers from intrinsic rewards to extrinsic acknowledgments.

4. The engagement platform of claim 3, including:
a state-chart mode whereby administrators or system designers define the engagement flow using a state-chart interface;
an agentic AI Mode wherein the engagement platform implements an AI agent such as a reinforcement learning or supervised learning model; and
a hybrid mode including AI-augmented state-chart adaptation wherein the engagement platform integrates the AI agent within the state-chart framework.

5. The engagement platform of claim 4, wherein the enhanced automated tutoring utilizes natural language processing and contextually relevant assistance to bridge the gap between generic support and user-specific needs.

6. The engagement platform of claim 5, wherein the hybrid automated coaching offers a combination of automated guidance using AI and LLM's and human interaction for comprehensive support for the user.

7. The engagement platform of claim 6, wherein the user management and process tracking system enables a process manager or teacher to quickly review individual user progress and determine if an intervention is needed, and allows users to communicate directly with the manager if problems arise.

8. A method for providing personalized engagement support, comprising:
receiving user input through a user interface of an engagement platform;
generating a customized engagement plan based on the user input;
providing adaptive messaging through the user interface, wherein the adaptive messaging includes dynamic communication adjusted using machine learning based on user feedback, overall usage, and engagement levels achieved;
delivering user content including diverse behavioral incentives, balanced gamification elements, enhanced automated tutoring, and hybrid automated coaching;
tracking user progress using constructive progress tracking; and
facilitating collaborative coordination through just-in-time group formation within an online community.

9. The method of claim 8, wherein the diverse behavioral incentives include intrinsic rewards and extrinsic acknowledgements catering to a wide range of motivational drivers.

10. The method of claim 9, wherein the balanced gamification elements include competitive aspects and personal achievement recognition.

11. The method of claim 10, wherein the enhanced automated tutoring utilizes natural language processing to provide contextually relevant assistance bridging the gap between generic support and user-specific needs.

12. The method of claim 11, wherein the hybrid automated coaching combines automated guidance using AI and LLM's with human interaction to provide comprehensive support tailored to individual user needs.

13. The method of claim 12, wherein tracking user progress includes generating actionable insights and providing detailed constructive feedback.

14. The method of claim 13, further comprising enabling process managers or teachers to quickly review individual user progress and determine if an intervention is needed.

15. A non-transitory computer-readable medium storing instructions that, when executed by a processor, cause the processor to perform operations for an engagement platform, the operations comprising:
presenting a user interface for receiving user input;
generating adaptive messaging based on the user input, wherein the adaptive messaging is dynamically adjusted using machine learning based on user feedback, overall usage, and engagement levels achieved;
providing user content including diverse behavioral incentives, balanced gamification elements, enhanced automated tutoring, and hybrid automated coaching;
implementing granular, constructive progress tracking; and
managing user engagement through a user management and process tracking system.

16. The non-transitory computer-readable medium of claim 15, wherein the diverse behavioral incentives include intrinsic rewards and extrinsic acknowledgements catering to different user motivations.

17. The non-transitory computer-readable medium of claim 16, wherein the operations include use of a plurality of service modes comprising:
a state-chart mode whereby administrators or system designers define the engagement flow using a state-chart interface;
an agentic AI Mode wherein the engagement platform implements an AI agent such as a reinforcement learning or supervised learning model; and
a hybrid mode including AI-augmented state-chart adaptation wherein the engagement platform integrates the AI agent within the state-chart framework.

18. The non-transitory computer-readable medium of claim 17, wherein the enhanced automated tutoring utilizes natural language processing to provide contextually relevant assistance.

19. The non-transitory computer-readable medium of claim 18, wherein the hybrid automated coaching combines automated guidance using AI and LLM's with human interaction for personalized support.

20. The non-transitory computer-readable medium of claim 19, wherein the granular, constructive progress tracking generates actionable insights and provides detailed feedback to users.
